(19) United States
(12) Patent Application Publication
(10) Pub. No.: US 2022/0185069 A1
(43) Pub. Date: Jun. 16, 2022

(54) VEHICLE ZONE HEATING SYSTEM

(71) Applicant: LEAR CORPORATION, Southfield, MI (US)

(72) Inventors: Larry Francis Kocher, Canton, MI (US); Travis Peterson, Troy, MI (US)

(21) Appl. No.: 17/119,642

(22) Filed: Dec. 11, 2020

(51) Int. Cl. B60H 1/22; B60H 1/00

(52) U.S. Cl. CPC B60H 1/2226; B60H 1/00295; B60H 1/00742; B60H 1/00285

(57) ABSTRACT

Multiple vehicle heating systems are disclosed providing a multilayered heating fabric to provide thermal radiation to vehicle occupants. In one embodiment, a heating system comprises a plurality of electrical bus bars and a heating fabric. The plurality of electrical bus bars connect to a battery within a vehicle to receive electrical power. The heating fabric comprises a conductive layer, and a non-conductive layer. The conductive layer comprises a plurality of non-uniform conductive fibers disbursed within a binder. The non-uniform conductive fibers are in electrical communication with at least two of the plurality of electrical bus bars. The non-uniform conductive fibers are adapted to convert electrical power to thermal radiation. The non-conductive layer insulates the conductive layer from the vehicle.

### TECHNICAL FIELD

The present disclosure relates to systems and methods for heating an electric vehicle interior.

### BACKGROUND

Conventional vehicles may include an HVAC system that heats a vehicle cabin by circulating engine heat using fans. Electrified vehicles, including electric vehicles and plug-in hybrid electric vehicles, include alternative heating methods to traditional HVAC systems currently provided today. For example, such electrified vehicles may include an electric heater that generates heat, and fans to circulate the heat within the vehicle cabin.

### SUMMARY

In one embodiment, a heating system is provided with a heating fabric and a controller. The heating fabric assembly is provided a plurality of electrical bus bars, a conductive layer, and a non-conductive layer. The plurality of electrical bus bars mount to a vehicle frame. Further, the electrical bus bars connect to an electrical power source. The conductive layer has a plurality of non-uniform conductive fibers disbursed within a binder. The conductive fibers extend between and are in electrical communication with at least two of the plurality of electrical bus bars. The non-conductive layer insulates the conductive layer from the vehicle frame. The controller is programmed to, in response to a request to heat a zone of a plurality of vehicle zones of a vehicle interior, operate a pair of the electrical bus bars of the plurality of electrical bus bars corresponding to the requested zone.

In another embodiment, a vehicle seating assembly is provided with a first seat back disposed on a vehicle seat frame of a vehicle interior. The first seat back has a first heating fabric disposed within. The first heating fabric is associated with and in electrical communication with a first pair of electrical bus bars. The vehicle seating assembly further comprises a first headliner disposed on the vehicle frame. The headliner has a second heating fabric disposed within the first headliner. The second heating fabric is associated with and in electrical communication with a second pair of electrical bus bars. Even further, the vehicle seating assembly comprises a controller. The controller is programmed to, in response to a request to provide electrical energy to one of the first heating fabric and the second heating fabric, enable the associated pair of first and/or second pair electrical bus bars.

In yet another embodiment, a vehicle heating method is provided. A first signal is received from an occupant to start a vehicle. Next, the method determines if an occupant is occupying a first location within a vehicle, the first location being in thermal communication with a first set of heating fabrics in electrical communication with a first set of electrical bus bars. This is followed by determining if an occupant is occupying a second location within a vehicle, the second location being in thermal communication with a second set of heating fabrics in electrical communication with a second set of electrical bus bars. Further, the method enables the operation of a first set of electrical bus bars in response to a determination that an occupant is occupying the first location. Also, the method enables the operation of a second set of electrical bus bars in response to a determination that an occupant is occupying the second location.

### BRIEF DESCRIPTION OF THE DRAWINGS

FIG. 1 is a schematic diagram of an electrified vehicle with a heating system and illustrating a heating zone layout according to one or more embodiments.

FIG. 2 is a top view of a heating fabric of the heating system of FIG. 1.

FIG. 3 is a section view of heating fabric of FIG. 2 taken along section line II-II.

FIG. 4 is a flow chart illustrating a method for heating a vehicle according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

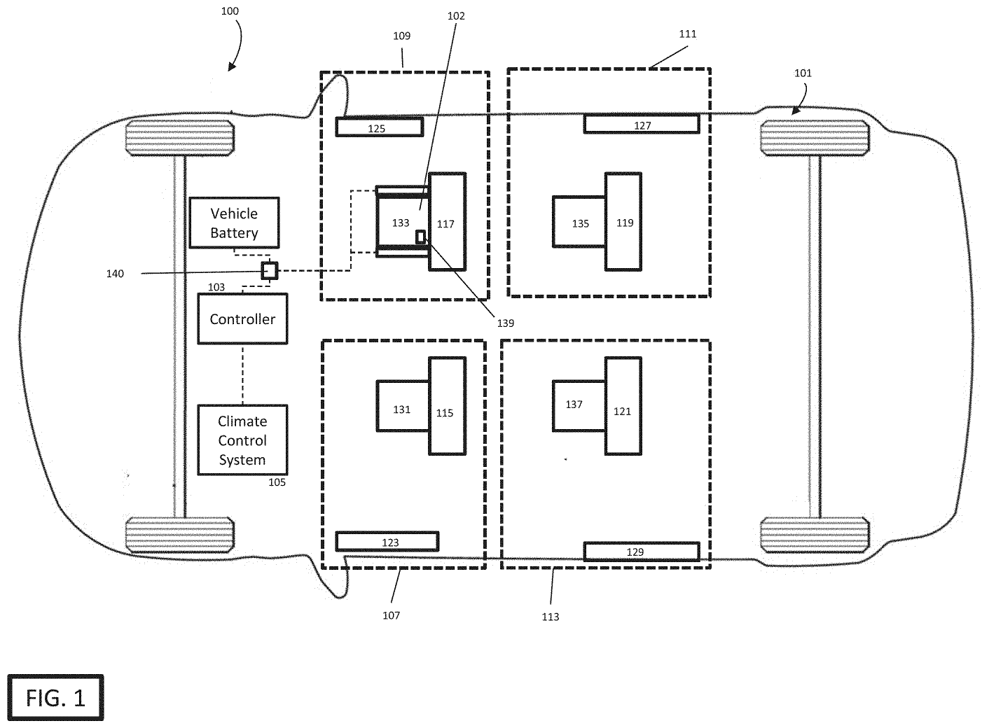

With reference to FIG. 1, a heating system 100 is illustrated in accordance with one or more embodiments and generally referenced by numeral 100. The heating system 100 is depicted within a vehicle 101, such as an electrified vehicle. The heating system 100 includes a fabric 102 that radiates heat within the vehicle 101. The fabric 102 is disposed within a vehicle surface interior surface, such as a seat, arm rest, head rest, headliner, console, dash, steering wheel, or door panel. The heating system 100 includes a controller 103 that activates the fabric 102 to generate heat in response to user input or sensor input. For example, the vehicle 101 includes a climate control system 105, with features for a user to manually select a heat setting e.g., a touch screen, buttons, knobs, etc., that provides a heat command to the controller 103 in response to user input.

The heating system 100 may heat individual zones within a passenger compartment 106 of the vehicle 101. The passenger compartment 106 may be divided into a driver zone 107, a front passenger zone 109, a right rear passenger zone 111, and a left rear passenger zone 113. The fabric 102 may be integrated into one or more of components in each zone. Each of the driver zone 107, front passenger zone 109, right rear passenger zone 111, and left rear passenger zone 113 includes a plurality of electrical bus bars that are connected to the fabric 102.

The controller 103 may be in electrical communication with a plurality of electrical bus bars 138 within the vehicle 101. The controller 103 selectively operates the plurality of electrical bus bars 138. The controller 103 may operate the plurality of electrical bus bars 138 by operating a switch 140. The plurality of electrical bus bars 138 may be selectively connected to a vehicle battery 141. The controller 103 may be programmed to assign some of the plurality of electrical bus bars 138 to a first zone, and other electrical bus bars 138 to a second zone. For example, the first zone may be the driver zone 107 and the second zone may be a passenger zone. In embodiments having a driver zone 107, the driver zone 107 may include a driver vehicle seat back 115, a driver headliner 123, a driver vehicle seat bottom 131, a steering wheel, a console, a driver interior door, or a driver side dash. Some embodiments may include at least one passenger zone. For example, the vehicle 101 may have a front passenger zone 109, a right rear passenger zone 111, and a left rear passenger zone 113. The front passenger zone 109 may include a front passenger vehicle seat back 117, a front passenger headliner 125, a front passenger vehicle seat bottom 133, a console, a passenger interior door, or a passenger side dash. A rear passenger zone may include a right rear passenger seat back 119, a right rear passenger headliner 127, a right rear passenger seat bottom 135, a left rear passenger seat back 121, a left rear passenger headliner 129, a left rear passenger seat bottom 137, a console, a left rear passenger door interior, or a right rear passenger door interior.

The controller 103 may further be programmed to assign some of the electrical bus bars 138 to groups. For example, the controller 103 may assign all electrical bus bars associated with heating one of the plurality of zones, and with a heated seating group. This may allow the user to select between a group consisting of seat backs to operate, and a second group constating of headliners to operate. The user may select between the groups using the climate control system 105. The controller 103 may be further configured to accept an input from the climate control system 105 The controller 103 may operate a single zone or multiple zones of the vehicle 101. For example, the controller 103 may selectively operate only the electrical bus bars 138 in a driver zone 107.

The controller 103 may selectively inhibit electrical bus bars 138 in a single zone of the vehicle 101. For example, the controller 103 may selectively inhibit only the electrical bus bars 138 in the driver zone 107. The controller 103 is programmed to one of inhibit or operate one of the zones in response to a heating command. The controller 103 may inhibit heating a zone if there are no occupants present in the zone. The controller 103 may operate various zones with various electrical parameters. For example, the controller 103 may limit current supplied to the fabric 102 in a driver zone 107 to 8 amps and limit current to a fabric 102 in a passenger zone to 22 amps. Additionally, or alternatively, the controller 103 may limit current supplied to one of the fabrics 102 in an analog fashion, such that a current range is provided. The current range may be from 8 amps to 22 amps. Various zones may be requested to operate with varying parameters from one of the occupants of the vehicle 101. The heating command may be provided to the controller 103 from the climate control system 105. The controller 103 may further receive the command from a remote device, such as a cell phone or a vehicle manufacturer remote server. Each of the driver zone 107, front passenger zone 109, right rear passenger zone 111, and left rear passenger zone 113 further include a seating sensor 139 that indicates whether an occupant is present in the zone. For example, the seating sensor 139 may be a pressure sensor, a proximity sensor, or a positioning sensor. The controller 103 is in communication with each seating sensor 139. The controller 103 may inhibit operation of the electrical bus bars 138 in a zone, in response to input that indicates that no occupant is present in that zone.

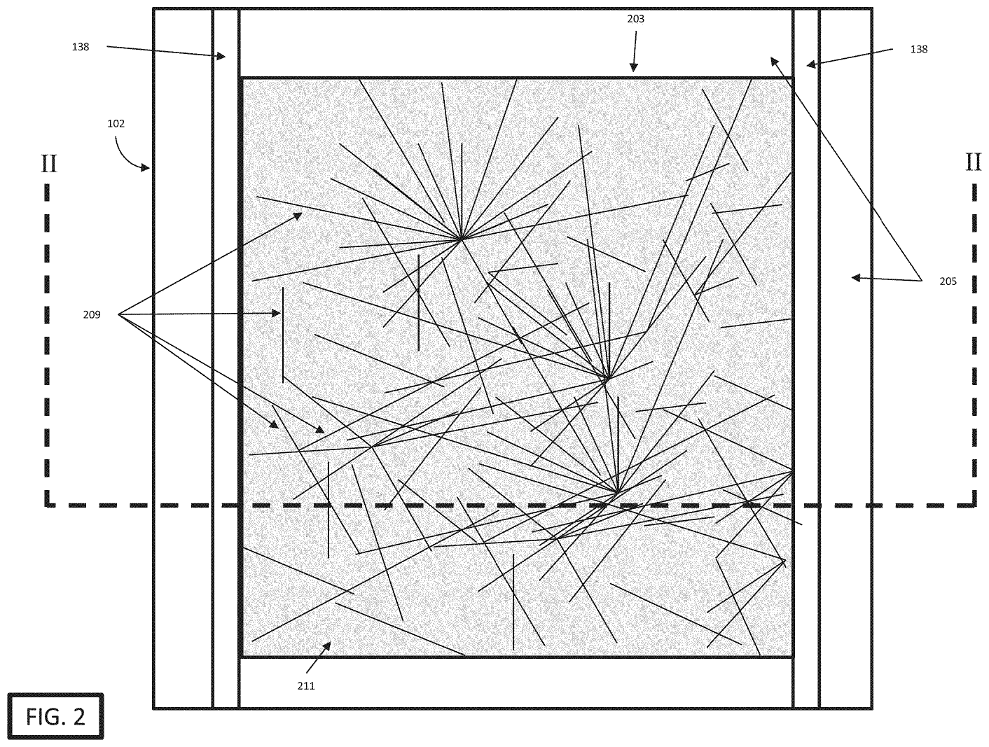

With reference to FIG. 2, the heating fabric 102 includes a conductive layer 203, a non-conductive layer 205, and a plurality of electrical bus bars 138. The conductive layer 203 may convert electrical energy into thermal radiation. To facilitate the conversion of energy, the conductive layer 203 may contain conductive fibers. The conductive layer 203 is embedded with a plurality of conductive fibers 209. The plurality of conductive fibers 209 may have a conductive portion and a non-conductive portion. In some embodiments, the non-conductive portion may be disposed at least partially within the conductive portion. The non-conductive portion may serve as a base in which to coat with a conductive chemical. The conductive chemical coating may serve as the conductive portion. The conductive portion may be composed of a conductive element. As such, the conductive portion may be composed of a metal. Even further, the conductive portion may be composed of a plurality of chemicals. In such embodiments, at least one of the plurality of chemicals may be a metal. In some embodiments, a portion of the conductive portion is a metal, e.g., nickel. Nickel may be combined with other chemicals to serve as the conductive portion. The chemical in addition to nickel may be generally non-conductive. For example, carbon may be used along with nickel as a nickel coated carbon compound to serve as a conductive fiber.

In compounds having a plurality of chemicals within the conductive layer 203, the electrical conductivity or thermal conductivity of the conductive fibers 209 may vary. Conductive variance may be a function of a concentration within the material. The concentration may be defined by the amount of conductive material within the conductive layer 203 in comparison to the amount of total material within the conductive layer 203. The amount of material may be measured in weight, mass, volume, or other units of size measurements. Additionally, or alternatively, the concentration may be defined as the amount of conductive material disposed on a surface of an area in comparison to the amount of total material disposed on a surface of an area. In some embodiments of the fabric, the concentration may be at least 90%. For example, the conductive layer 203 may be 90% nickel-coated carbon.

The plurality of conductive fibers 209 may be composed of an electrically conductive material. The plurality of conductive fibers 209 are nickel. Alternatively, the plurality of conductive fibers 209 may be nickel coated carbon. Even further, the plurality of conductive fibers 209 may be other alloys. The plurality of conductive fibers 209 is non-uniform. As such the plurality of conductive fibers 209 are of different lengths. In some embodiments, the plurality of conductive fibers 209 are of different thicknesses. For example, some of the conductive fibers may be 0.5 mm in length, while others are 0.7 mm in length. The conductive fibers may range from 0.1 mm to 100 mm in length. The plurality of conductive fibers 209 are of different orientations. The concentration of the plurality of conductive fibers 209 may be at least 90% within the heating fabric 102.

In addition to the conductive fibers 209, the conductive layer 203 further includes a binder 211. The binder 211 may be composed of an electrical insulative material. In one embodiment, the binder 211 is composed of one of a urethane and urethane derivative. The binder 211 is used to bind the plurality of conductive fibers 209. The binder 211 may be resistant to conductivity of at least one of thermal radiation and electrical current. In the present embodiment, the binder 211 is thermally conductive. Further, the binder 211 is electrically resistant. The non-conductive layer 205 insulates a vehicle from both electrical current and thermal radiation traveling throughout the conductive layer 203. The non-conductive layer 205 is placed between the conductive layer 203 and a vehicle. The binder 211 may further be used to shape the conductive layer 203. As such, the binder 211 may be flexible. The binder 211 may have a first matter phase in which it is flexible, and a second matter phase in which it is still flexible, yet more resilient than the first. The first matter phase may be experienced by the binder 211 at a first binder temperature and the second matter phase may be experienced at a second binder temperature, in which the first binder temperature is greater than the second binder temperature. The second binder temperature may generally be 22° Celsius (72° Fahrenheit). In some embodiments, while the binder 211 is resistant to electrical current, the binder 211 is thermally conductive.

Binders of these parameters may be useful in maintaining a level of electrical insulation, while not wasting energy for thermal radiation by providing an efficient ratio of energy upon the request of a user. In manufacturing the conductive layer 203 of the heating fabric 102, the conductive fibers may be combined with the binder 211. The combination may be done by mixing the conductive fibers and the binder 211. In the mixture of the conductive fibers and the binder 211, the conductive fibers may be non-uniform. Some embodiments of the conductive layer 203 may be formed as a sheet. The thickness of the mixture may be approximately between 0.5 mm and 1 mm in thickness. As such, the combination of the binder 211 and the conductive fibers may be attached to and around various curvatures and corners. The conductive layer 203 may be mounted to the vehicle 101 via an adhesive substance. The thickness of the mixture further allows the conductive layer 203 to be cut for fitting to various positions in a vehicle 101. The sheet mixture may then receive a layer of adhesive to be applied onto a desired surface. Other embodiments of the conductive layer 203 may be formed as a fluid or partial liquid. As such, the fluid mixture may be applied to a non-conductive surface via a fluid applicator. For example, the fluid mixture may be sprayed onto a desired surface. Other methods of installation of the conductive fiber material include thermoplastic adhesive films and webs, thermoset flame lamination, and fiber integration.

The fabric 102 may include a non-conductive layer 205. The non-conductive layer 205 may be resistant to electrical communication. As such, the non-conductive layer 205 may serve as an electrical insulator between the fabric 102 and the vehicle 101. Further the non-conductive layer 205 may serve as an electrical insulator between the fabric 102 and the occupant. The non-conductive layer 205 may further be resistant to thermal radiation. In embodiments in which a non-conductive layer 205 is located between the vehicle frame and the conductive layer 203, the non-conductive layer 205 may serve to direct thermal radiation to an occupant instead of to the vehicle 101.

The plurality of electrical bus bars 138 is used to provide electrical energy to the plurality of conductive fibers 209 via the conductive layer 203. In some embodiments, one of the electrical bus bars 138 may be a positive bus bar. Additionally, another of the electrical bus bars 138 may be a negative bus bar. In embodiments as such, the conductive layer 203 may use direct electrical current to convert electrical energy into thermal radiation. Alternatively, other embodiments may use a pair of electrical bus bars 138 from the plurality of electrical bus bars 138 to cooperate as an alternative electrical current source. In such embodiments, the conductive layer 203 may use alternating electrical current from a vehicle generator to convert electrical energy into thermal radiation. The plurality of conductive fibers 209 converts electrical energy from the plurality of electrical bus bars 138 into thermal radiation to travel from the plurality of conductive fibers 209 to an occupant. The plurality of electrical bus bars 138 are disposed to allow general uniform current throughout the conductive layer 203. As shown, the plurality of electrical bus bars 138 are cooperating DC electrical poles. Alternatively, plurality of electrical bus bars 138 may be cooperating AC electrical poles.

The conductive layer 203 of the heating fabric 102 may be capable of receiving an electrical parameter of a predetermined threshold to increase a temperature at a predetermined rate. Examples of electrical parameters that may affect the temperature of the conductive layer 203 are electrical current, electrical voltage, electrical phase, electrical frequency, and electrical power. In one embodiment, the conductive layer 203 may be capable of receiving a predetermined electrical current of 8 Amps. In an embodiment capable of receiving 8 amps, the conductive layer 203 may be capable of rising in temperature at a rate of 49° Celsius (88° Fahrenheit) per minute. In other embodiments, the conductive layer 203 maybe be capable of receiving a predetermined electrical current of 22 amps. In an embodiment capable of receiving 22 amps, the conductive layer 203 may be capable of rising in temperature at a rate of 72° Celsius (130° Fahrenheit). To ensure the rise in temperature of the conductive layer 203 does not fall behind or exceed the desired rate of temperature increase, the conductive fiber concentration may be adjusted for varying electrical parameters.

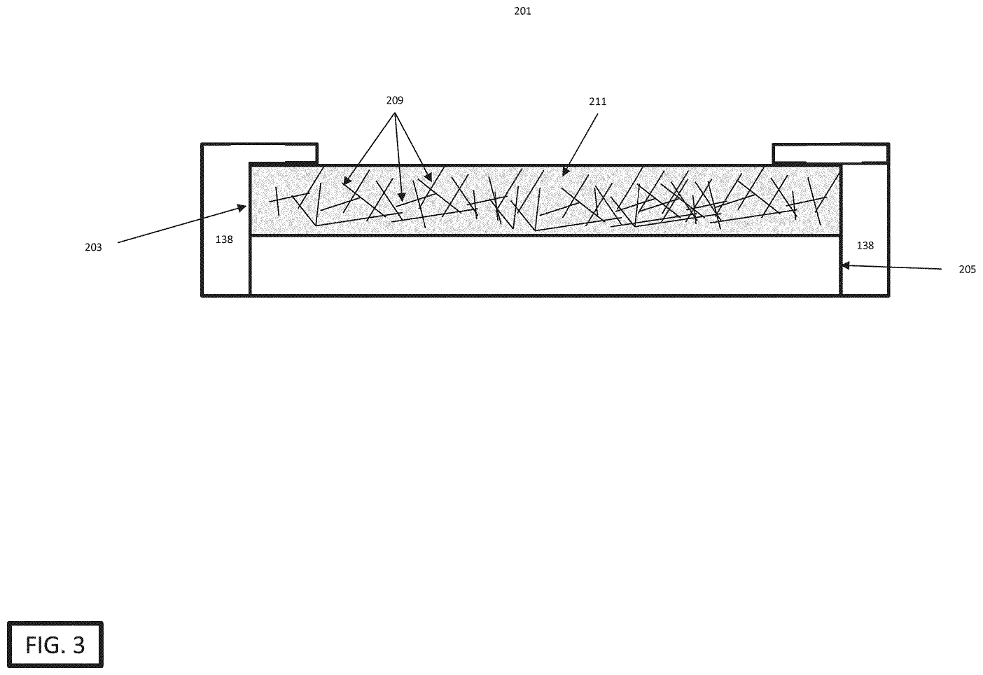

FIG. 3 illustrates the variation of pattern and depth of the plurality of conductive fibers 209 within the conductive layer 203 of the heating fabric 102. The heating fabric 102 may have a second non-conductive layer. The second non-conductive layer may be electrically resistant yet thermally conductive.

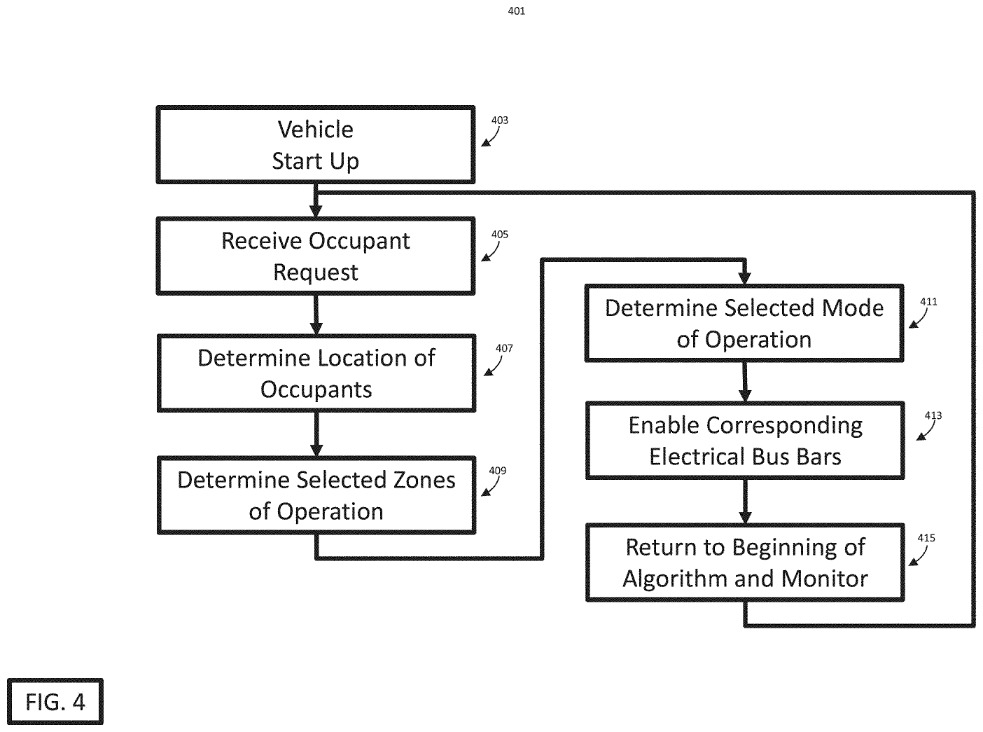

With reference to FIG. 4, a method for heating the vehicle 101 is illustrated in accordance with one or more embodiments and generally referenced by numeral 400. The method 400 is implemented using software code contained within the controller 103 according to one or more embodiments. While the method is described using flowcharts that are illustrated with a number of sequential steps, one or more steps may be omitted and/or executed in a different order in one or more other embodiments. In other embodiments, the software code is distributed among multiple controllers, e.g., the controller 103 and one or more vehicle controllers (not shown).

Although the controller 103 is shown as a single controller, it may contain multiple controllers, or may be embodied as software code within one or more other controllers. The controller 103 generally includes any number of microprocessors, ASICs, ICs, memory (e.g., FLASH, ROM, RAM, EPROM and/or EEPROM) and software code to co-act with one another to perform a series of operations. Such hardware and/or software may be grouped together in assemblies to perform certain functions. Any one or more of the controllers or devices described herein include computer executable instructions that may be compiled or interpreted from computer programs created using a variety of programming languages and/or technologies. In general, a processor (such as a microprocessor) receives instructions, for example from a memory, a computer-readable medium, or the like, and executes the instructions. A processing unit includes a non-transitory computer-readable storage medium capable of executing instructions of a software program. The computer readable storage medium may be, but is not limited to, an electronic storage device, a magnetic storage device, an optical storage device, an electromagnetic storage device, a semi-conductor storage device, or any suitable combination thereof. The controller 103, also includes predetermined data, or “look up tables” that are stored within memory, according to one or more embodiments.

At step 403, the vehicle 101 is requested to start. The vehicle start step 403 may be initiated with a key or remotely. The vehicle heating algorithm 401 then moves to a receive occupant request 405, in which the controller 103 gathers data indicative of a user request to heat a zone. Next, the vehicle heating algorithm 401 moves to a determine occupants' step 407, in which the controller 103 polls the seating sensor 139 to determine the number of seated occupants. In the determine selected zone step 409, the controller 103 determines the zones to heat within the vehicle based upon the commands and occupants seated. In the determine selected group step 411, the controller 103 determines the operation group to apply for the selected zones. In the enable corresponding electrical bus bar step 413, the controller 103 operates the plurality of electrical bus bars 138 according to the determine selected zone step 409 and determine selected group step 411 as previously described above. Last, in step 415, the vehicle heating algorithm 401 moves back to the receive occupant request 405 to continuously monitor the status of the request within the vehicle 101.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A heating system comprising:
a plurality of electrical bus bars to connect to a battery within a vehicle to receive electrical power;
a first heating fabric comprising:
a conductive layer comprising a plurality of non-uniform conductive fibers disbursed within a binder and in electrical communication with at least two of the plurality of electrical bus bars, wherein the plurality of non-uniform conductive fibers is adapted to convert electrical power to thermal radiation; and
a non-conductive layer insulating the conductive layer from the vehicle.

2. The heating system of claim 1 further comprising a second heating fabric, such that the first heating fabric and the second heating fabric define a plurality of heating fabrics, and at least one heating fabric of the plurality of heating fabrics is disposed within one vehicle zone of a plurality of vehicle zones, the heating system further comprising:
a controller programmed to:
receive input indicative of a request to heat the one vehicle zone, and
connect a pair of the plurality of electrical bus bars corresponding to the one vehicle zone to the battery.

3. The heating system of claim 2, wherein the plurality of vehicle zones comprise a driver zone, a front passenger zone, a right rear passenger zone, and a left rear passenger zone.

4. The heating system of claim 3, wherein at least one of the vehicle zones is defined by at least one of a headliner and a vehicle seat back.

5. The heating system of claim 3, further comprising a plurality of seating sensors to provide input indicative of occupant presence, at least one of the plurality of seating sensors disposed in the driver zone, the front passenger zone, the right rear passenger zone, and the left rear passenger zone.

6. The heating system of claim 3, wherein the controller is further programmed to inhibit operation of a pair of the plurality of electrical bus bars in response to a seating sensor of a plurality of seating sensors indicating that the corresponding vehicle zone is vacant.

7. The heating system of claim 1, further comprising a controller configured to:
receive a remote command to heat a first vehicle zone;
operate a pair of the electrical bus bars of the plurality of electrical bus bars corresponding to the first vehicle zone, wherein the first vehicle zone includes at least one of a driver zone, a front passenger zone, a right rear passenger zone, and a left rear passenger zone.

8. The heating system of claim 1, wherein the conductive fibers are composed of nickel coated carbon.

9. The heating system of claim 1, wherein the conductive layer is composed of at least a concentration of 90% nickel coated carbon.

10. The heating system of claim 1, wherein the conductive layer is formed as a sheet to mount to a vehicle interior via an adhesive substance.

11. The heating system of claim 1, wherein the heating fabric is disposed in at least one of a vehicle seat, a vehicle headliner, and a vehicle console.

12. A vehicle seating assembly comprising:
a first seat back disposed on a vehicle seat frame of a vehicle interior, the first seat back having a first heating fabric disposed within the first seat back, wherein the first heating fabric includes a conductive layer having a plurality of non-uniform conductive fibers, the first heating fabric being associated with and in electrical communication with a first pair of electrical bus bars; and
a first headliner disposed on the vehicle seat frame, the headliner having a second heating fabric disposed within the first headliner, wherein the second heating fabric is associated with and in electrical communication with a second pair of electrical bus bars; and
a controller programmed to,
in response to a request to provide electrical energy to one of the first heating fabric and the second heating fabric, enable one of the first pair of electrical bus bars and second pair of electrical bus bars corresponding to the request.

13. The vehicle seating assembly of claim 12, wherein the first seat back and first headliner define a driver zone, and
wherein the seating assembly further comprises a passenger zone, having a second seat back in which a third heating fabric is associated with and in electrical communication with a third pair of electrical bus bars, and a second headliner in which a fourth heating fabric is associated with and in electrical communication with a fourth pair of electrical bus bars.

14. The vehicle seating assembly of claim 13, further comprising a controller programmed to,
in response to a receipt of a second request to provide electrical energy to one of the third heating fabric and the fourth heating fabric, enable one of the third pair of electrical bus bars and fourth pair of electrical bus bars corresponding to the request.

15. The vehicle seating assembly of claim 14, wherein the controller is further programed to assign at least one of the first seat back, second seat back, first headliner, and second headliner to a group.

16. The vehicle seating assembly of claim 15, wherein one of the first seat back and the second seat back define the group.

17. The vehicle seating assembly of claim 15, wherein one of the first headliner and the second headliner define the group.

18. A vehicle heating method comprising:
providing a first set of heating fabrics having non-uniform conductive fibers in electrical communication with a first set of electrical bus bars in a first vehicle zone and a second set of heating fabrics having non-uniform conductive fibers in electrical communication with a second set of electrical bus bars in a second vehicle zone;
receiving input indicative of occupant presence within at least one of the first vehicle zone and the second vehicle zone;
enabling a first operation of the first set of electrical bus bars in response to occupant presence within the first zone; and
enabling a second operation of the second set of electrical bus bars in response to occupant presence within the second zone.

19. The vehicle heating method of claim 18, further comprising inhibiting the second operation of the second set of electrical bus bars in response to input indicative of no occupant presence in the second zone.

20. The vehicle heating method of claim 18, further comprising:
receiving input indicative of a heat command to heat one of the first zone and the second zone from a remote source; and
enabling the first operation or the second operation in response to the heat command.
